(19) United States
(12) Patent Application Publication
(10) Pub. No.: US 2003/0169680 A1
(43) Pub. Date: Sep. 11, 2003

(54) Protective enclosure for data storage cartridge

(76) Inventors: Gregory Dimitri Volan, Longmont, CO (US); Daniel Anthony Estoque, Boulder, CO (US); William Boyd Stephens, Boulder, CO (US)

Correspondence Address: MR. STEVE VOLK, CHAIRMAN OF THE BOARD, DATAPLAY, INC., 2560 55TH STREET, BOULDER, CO, 80301-5706, US

(21) Appl. No.: 10/095,150

(22) Filed: Mar. 8, 2002

(51) Int. Cl. G11B 3/70; G11B 5/84; G11B 7/26; B65D 85/30; B65D 85/57

(52) U.S. Cl. 369/291; 206/308.1

(57) ABSTRACT

A protective enclosure for a cartridge for holding a data storage medium (such as an optical disk) includes a mating cover and base connected to one another with a live hinge having an axis of rotation. The cover contains a lip which surrounds all or part of an enclosure space within the enclosure. The lip mates with a recess in the base to keep dust and debris out of the protective enclosure. Clasps which extend from the cover and base, respectively, mate with each other to maintain the enclosure closed. A number of protrusions extend into the enclosure space and make contact with a data storage cartridge, thereby holding the cartridge in a defined position within the enclosure.

### FIELD OF THE INVENTION

This invention relates to protective enclosures for data storage cartridge such as a cartridge for holding an optical data storage disk.

### BACKGROUND

Cartridges for holding optical disks and other data storage media (sometimes referred to herein as “data storage cartridges”) may be susceptible to damage or loss when stored or transported. An example of a data storage cartridge is described in U.S. application Ser. No. 09/548,128, incorporated herein by reference in its entirety. To protect against such damage or loss, the cartridge may be kept in a case when not in use. However, such cases do not always provide adequate protection for the cartridge and the data storage medium inside, and may be awkward or difficult to transport.

### SUMMARY

A protective enclosure for a data storage cartridge provides a secure container for the cartridge and protects the cartridge and the data storage media from damage.

In one aspect of the invention, a protective enclosure for the cartridge includes a mating cover and base connected by a live hinge. The cover and/or base have a domelike shape, providing resistance to deformation under load to protect the storage medium within.

In another aspect of the invention, one clasp extends from the cover of the enclosure and one clasp extends from the base of the enclosure. One clasp includes a lip, and the other clasp includes an interlocking feature that engages the lip when the enclosure is closed. The clasps may be disengaged from one another with a one-handed motion to provide for easy access to the storage medium within the enclosure.

In another aspect of the invention, at least one of the clasps has a passage therethrough. A lanyard, keychain, rod, or other strand of material may be threaded through the passage. In this way, the enclosure may be easily carried by a user. Further, two or more cases may easily be strung together for convenience in transporting them.

In another aspect of the invention, an offset lip extends around at least a portion of the cover of the enclosure, and a corresponding recess is formed in the base. If desired, the offset lip may be provided on the base, and the recess may be provided on the cover. The offset lip and corresponding recess provide for registration of the cover to the base, and provide a seal against external dust and debris.

In another aspect of the invention, a feature for machine registrability is provided on at least one side of the enclosure. Such a feature may be a flat facet having a protruding lip. Different features may be provided on different sides of the enclosure. The orientation of the enclosure thus can be determined by a machine, and the enclosure can be position-registered and manipulated to specific positions and orientations as desired.

In another aspect of the invention, the enclosure space is shaped to allow the cartridge to be placed therein in more than one orientation.

In another aspect of the invention, at least one protrusion extends into the enclosure space that contacts the cartridge within to provide a friction fit. In this way, the cartridge is held in place even when the enclosure is open, in order to prevent the cartridge from falling out of the enclosure and being damaged or lost. Further, if the cartridge is loaded into the enclosure in an automatic handling environment, the cartridge can be pressed into the enclosure space and into affirmative engagement with the at least one protrusion by a robot or other device. The cartridge is thus protected in a secure and consistent manner.

The invention will be more fully understood upon consideration of the detailed description below, taken together with the accompanying drawings.

### BRIEF DESCRIPTION OF THE DRAWINGS

FIG. 1 is a perspective view of the enclosure in a partially-open position and a data storage cartridge within the enclosure.

FIG. 2 is a perspective view of the enclosure in a fully open position and a data storage cartridge within the enclosure.

FIG. 3 is a perspective view of the enclosure in a closed position.

FIG. 4 is a perspective view of the empty enclosure in a fully-open position.

FIG. 5 is a perspective view of the enclosure in a fully-open position, showing the outer surfaces of the enclosure.

FIG. 6 is an exploded view of a data storage cartridge and the enclosure in a partially-open position.

Use of the same reference symbols in different figures indicates similar or identical items.

### DETAILED DESCRIPTION

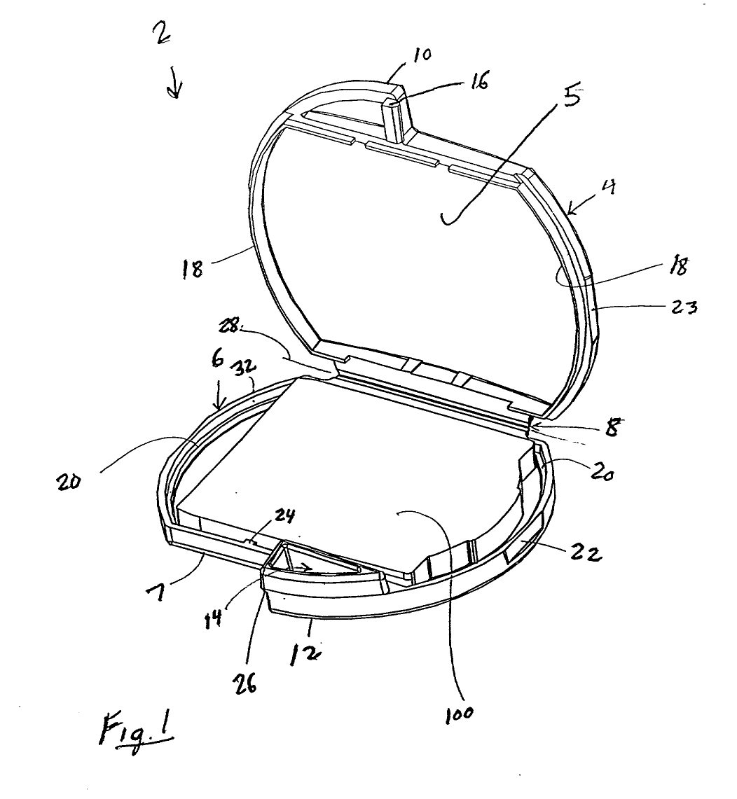

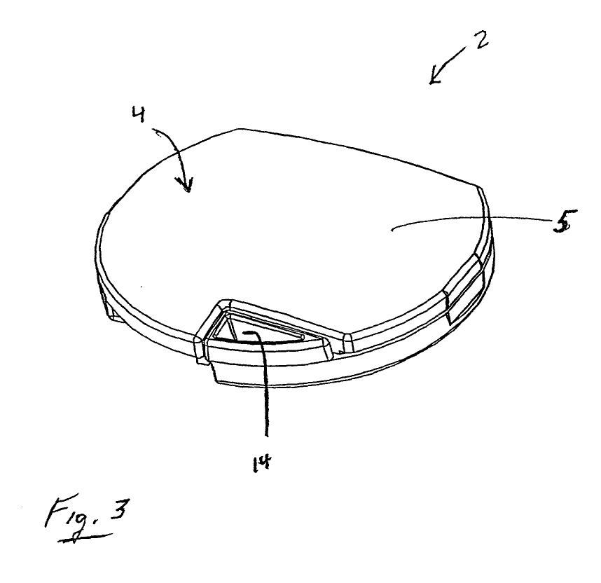

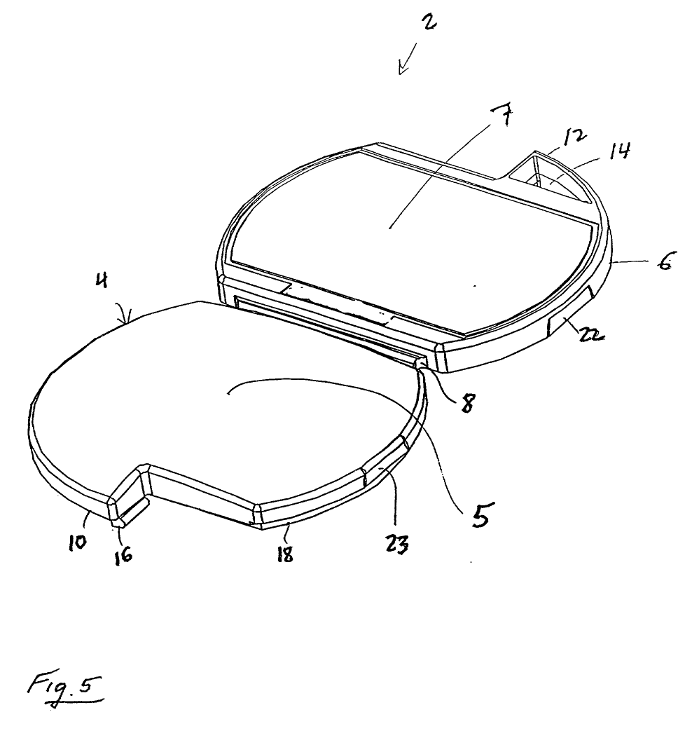

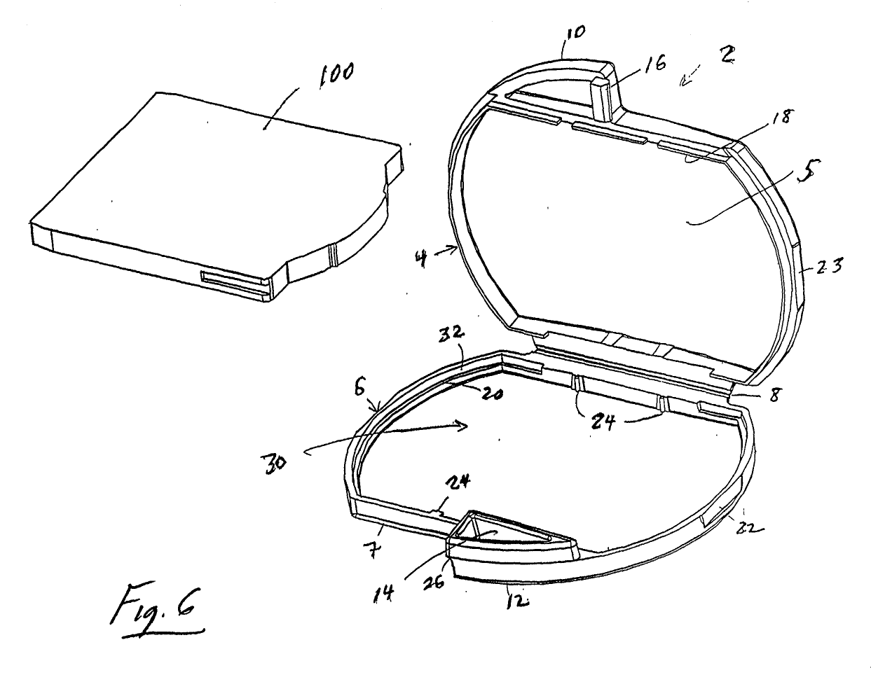

Referring to FIGS. 1-6, a protective enclosure 2 is shown. The protective enclosure 2 receives and protects a cartridge 100 for holding a data storage media such as an optical disk (sometimes referred to herein as a “data storage cartridge”). The protective enclosure 2 can be manufactured from polypropylene. Polypropylene provides a degree of flexibility for the protective enclosure 2 to enhance its durability. Further, polypropylene is an inert material, thereby providing protection against contamination of the storage medium 100 from outgassing of the protective enclosure 2. Additionally, polypropylene is durable and provides a relatively long life expectancy for the protective enclosure 2. Alternatively, another substantially inert and flexible material may be used to construct the protective enclosure 2. The storage medium 100 may be a removable optical disk cartridge. Alternatively, the storage medium 100 may be any structure or mechanism useful for storing data or other information, such as a removable hard disk, a video game cartridge, flash memory, or any other form of memory storage device.

The protective enclosure 2 includes a cover 4 connected to a base 6 by a live hinge 8. A live hinge is a flexible portion of a unitary structure that acts as a hinge, as is known to those skilled in the art. The live hinge 8 has an axis of rotation 28 about which the cover 4 and/or the base 6 rotate relative to one another when the protective enclosure 2 is opened or closed. The cover 4 has a dome-shaped upper surface 5. That is, the upper surface 5 of the cover 4 bows outward towards its center. When the protective enclosure 2 is closed, and force is exerted on the upper surface 5 of the cover 4, the upper surface 5 flexes, then stiffens as the upper surface 5 is deflected into a flattened shape. In this way, the cover 4 provides additional resistance to deformation under load, protecting the storage medium 100 within. The base 6 has a substantially flat lower surface 7. Alternatively, the lower surface 7 of the base 6 also has a dome-like shape as described above with regard to the upper surface 5. Alternatively, the upper surface 5 is substantially flat and the lower surface 7 has a dome-like configuration.

A first clasp 10 extends outward from the front portion of the cover 4. Correspondingly, a second clasp 12 extends from the front portion of the base 6. Alternatively, the first clasp 10 and the second clasp 12 extend from a different portion of the cover 4 and the base 6, respectively. A lip 16 is connected to the first clasp 10 and a corresponding interlocking feature 26 is provided in the second clasp 12. Alternately, the lip 16 extends from the second clasp 12 and the interlocking feature 26 is provided in the first clasp 10. The interlocking feature 26 is a recessed area sized and shaped to engage the lip 16 when the protective enclosure 2 is in the closed position, thereby holding the protective enclosure 2 closed. The lip 16 is substantially perpendicular to the axis of rotation 28 of the live hinge 8. Correspondingly, the interlocking feature 26 is substantially perpendicular to the axis of rotation 28 as well. The lip 16 and the interlocking feature 26 may be oriented in another direction, if desired. When the protective enclosure 2 is in the closed position, the lip 16 engages the interlocking feature 26. This engagement provides for positive closure of the protective enclosure 2. Force must be exerted upon the first clasp 10 and second clasp 12 to overcome resistance provided by the interface between the lip 16 and the corresponding interlocking feature 26, either to open the protective enclosure 2 or to close it completely. The clasps 10, 12 may be sized and shaped to facilitate the opening of the protective enclosure 2 with one hand.

A passage 14 is provided through the second clasp 12. Alternatively, the passage 14 is provided through the first clasp 10, or a separate passage 14 is provided through each clasp 12, 14. The passage 14 passes completely through the second clasp 12 in a direction substantially perpendicular to the axis of rotation 28 of the live hinge 8. The passage 14 may be oriented in a different direction, if desired. A lanyard, keychain, rod, or other structure or mechanism (not shown) can pass through the passage 14. The protective enclosure 2 may be connected to another structure or mechanism, and/or to one or more other protective enclosures 2, via such a lanyard, keychain, rod or other structure or mechanism passing through the passage 14 in the second clasp 12. By connecting the protective enclosure 2 to another structure or mechanism, its storage and transport may be facilitated. For example, if the protective enclosure 2 is relatively small, it can be better tracked and retained by connecting it to a number of other protective enclosures 2 via a lanyard or other item that passes through a number of different passages 14 on different protective enclosures 2. As another example, the protective enclosure 2 may be connected to a key chain or key ring that passes through the passage 14. In this way, a particular storage medium 100 that is frequently used by an individual may be stored in that protective enclosure 2 and kept close at hand.

A registration feature may be provided on the base 6 of the protective enclosure 2. In one embodiment, the registration feature is a flat facet 22 on one side of the base 6. By providing the flat facet 22 on a single side of the base 6, the protective enclosure 2 may be oriented, or the orientation of the protective enclosure 2 may be detected, by a machine that senses the flat facet 22. Thus, the protective enclosure 2 may be oriented, position-registered, and manipulated accurately by automatic handling equipment. The flat facet 22 may be provided on one or more additional sides of the base 6, if desired.

A lip 23 also extends outward from the cover 4, as another registration feature. When the protective enclosure 2 is in a closed position, the lip 23 substantially corresponds to the position of the flat facet 22, such that the lip 23 extends outward from and above the flat facet 22 to assist in orienting and registering the protective enclosure 2. Alternatively, the lip 23 may be located in another region of the cover 4, or one or more additional lips 23 may be provided on the cover 4. In another embodiment, the flat facet 22 is provided on the cover 4, and the lip 23 is provided on the base 6. Alternatively, one or more other registration features may be provided on the protective enclosure 2 instead of or in addition to the flat facet 22 and/or the lip 23. Alternatively, the lip 23 is not provided.

An offset lip 18 extends downward from and around at least a portion of the cover 4. A corresponding recess 20 is defined in the base 6. Alternatively, the offset lip 18 extends upward from and around at least a portion of the base 6, and the corresponding recess 20 is defined in the cover 4. When the protective enclosure 2 is closed, the offset lip 18 interfaces with the corresponding recess 20. In this way, the cover 4 is stabilized against the base 6, and dust and debris is substantially kept out of the protective enclosure 2. The offset lip 18 is offset slightly from the edge of the cover 4. The offset lip 18, and the corresponding recess 20, extend around the protective enclosure 2, except that there is a gap 27 in lip 18 in the vicinity of the live hinge 8. However, the offset lip 18 underlaps the live hinge 8 (i.e., gap 27 is not as wide as live hinge 8), such that the seal is substantially maintained around the entire perimeter of the protective enclosure 2. In other embodiments, lip 18 extends entirely around the enclosure space 30.

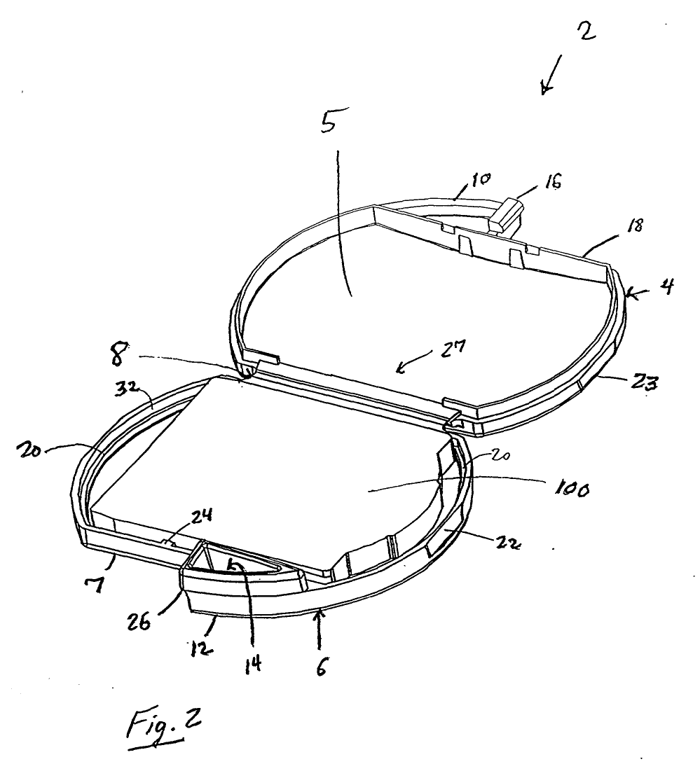

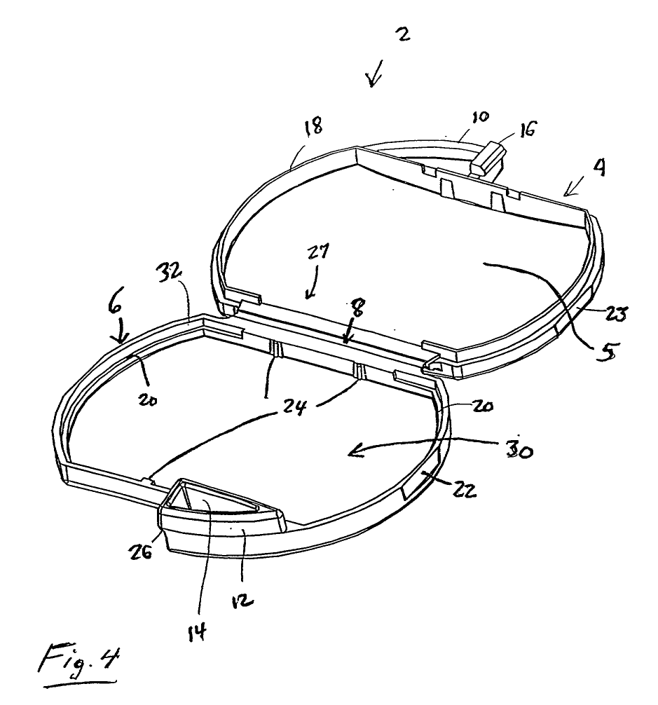

Referring in particular to FIGS. 2 and 4, protrusions 24 extend from the base 6 into an enclosure space 30. The enclosure space 30 is the space formed within the base 6 in which the storage medium 100 is stored, defined by a wall 32 of the base 6, where that wall 32 extends around the perimeter of the base 6. The recess 20 is defined in the wall 32. One or more protrusions 24 extend from the wall 32. In one embodiment, four protrusions 24 are symmetrically spaced on the wall 32, two each on opposite sides of the enclosure space 30. Alternatively, more or fewer protrusions 24 may be provided. The protrusions 24 provide for a friction fit with the storage medium 100. When the storage medium 100 is inserted into the enclosure space 300, the storage medium 100 frictionally engages the protrusions 24, such that the protrusions 24 assist in holding the storage medium 100 within the protective enclosure 2. The protrusions 24 are substantially semi-cylindrical solids extending substantially vertically on the wall 32. The protrusions 24 may also include rectangular solids placed behind the hemispherical solids such that the hemispherical solids are placed further into the enclosure space 30. The protrusions 24 may be shaped or oriented differently, if desired. The enclosure space 30 may be sized and shaped, and the protrusions 24 may be positioned, such that the storage medium 100 may be placed into the enclosure space 30 in more than one orientation. In another embodiment, the protrusions 24 may be present in the cover 4 of the protective enclosure 2, such that the storage medium 100 is stored within the cover 4. Alternatively, protrusions 24 may be provided in both the cover 4 and the base 6, depending on the particular configuration of the storage medium 100 and of the protective enclosure 2.

Although the invention has been described with reference to particular embodiments, this description is only exemplary of the invention and should not be taken as limiting. Various adaptations and combinations of features of the embodiments disclosed are within the scope of the invention as defined by the following claims and their legal equivalents.

What is claimed is:

1. A protective enclosure for a data storage medium, comprising:
a cover;
a base; and
a live hinge connecting said cover to said base, said live hinge having an axis of rotation.

2. The protective enclosure of claim 1, wherein said cover is domed.

3. The protective enclosure of claim 1, further comprising:
a first clasp extending from said cover; and
a second clasp extending from said base;
wherein said first clasp engages said second clasp to hold said cover and said base in a closed position.

4. The protective enclosure of claim 3, further comprising:
a lip extending from said first clasp; and
an interlocking feature defined in said second clasp, wherein said first clasp engages said second clasp by engaging said lip with said interlocking feature.

5. The protective enclosure of claim 3, further comprising:
an interlocking feature defined in said first clasp; and
a lip extending from said second clasp, wherein said first clasp engages said second clasp by engaging said lip with said interlocking feature.

6. The protective enclosure of claim 3, wherein said lip is substantially perpendicular to said axis of rotation of said live hinge.

7. The protective enclosure of claim 3, wherein said first clasp comprises a passage defined therethrough.

8. The protective enclosure of claim 1, wherein said cover further comprises an offset lip extending downward therefrom, and wherein said base further comprises a corresponding recess.

9. The protective enclosure of claim 1, wherein said base further comprises an offset lip extending upward therefrom, and wherein said cover further comprises a corresponding recess.

10. The protective enclosure of claim 1, wherein said base defines an enclosure space therein; further comprising at least one protrusion extending from said base into said enclosure space; wherein said at least one protrusion provides a friction fit against the storage medium.

11. The protective enclosure of claim 1, wherein said base defines an enclosure space therein, said enclosure space shaped to receive the storage medium in a plurality of different orientations.

12. The protective enclosure of claim 1, further comprising a registration feature on said base.

13. The protective enclosure of claim 12, wherein said registration feature is a flat facet.

14. The protective enclosure of claim 1, further comprising a registration feature in said cover.

15. The protective enclosure of claim 14, wherein said registration feature is a lip extending outward from said cover.

16. A combination comprising the protective enclosure of claim 1 and a data storage cartridge held in position within the protective enclosure.

17. A protective enclosure for a storage medium, comprising:
a cover;
a base;
a live hinge connecting said cover to said base, said live hinge having an axis of rotation;
a first clasp extending from said cover; and
a second clasp extending from said base, wherein said first clasp engages said second clasp to hold said cover and said base in a closed position;
wherein at least one said clasp comprises a passage defined therethrough.
